(19) United States
(12) Patent Application Publication
(10) Pub. No.: US 2024/0165912 A1
(43) Pub. Date: May 23, 2024

(54) COMPOSITES WITH BAST FIBERS HAVING MINIMUM BENDING LENGTHS

(71) Applicant: GM GLOBAL TECHNOLOGY OPERATIONS LLC, Detroit, MI (US)

(72) Inventor: Bradley Allen NEWCOMB, Troy, MI (US)

(21) Appl. No.: 17/989,172

(22) Filed: Nov. 17, 2022

(51) Int. Cl. B32B 5/06; B32B 5/02; B32B 5/12; B32B 7/022

(52) U.S. Cl. CPC B32B 5/073; B32B 5/022; B32B 5/024; B32B 5/12; B32B 7/022; B32B 2250/02; B32B 2260/021; B32B 2260/046; B32B 2262/065; B32B 2262/16; B32B 2307/41; B32B 2307/51; B32B 2307/514; B32B 2307/54; B32B 2307/72; B32B 2307/732; B32B 2607/00

(57) ABSTRACT

A composite panel includes a polymer matrix and a plurality of reinforcing fibers encapsulated in the polymer matrix. The plurality of reinforcing fibers includes bast fibers having a predetermined bending length greater than 80 μm and less than 2 mm.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to composites including bast fibers, and more particularly to composites with bast fiber having minimum bending lengths.

Natural fibers include bast, leaf, seed, wood, and grass stem. Bast fibers include flax, hemp, jute, ramie and kenaf. To increase sustainability and renewability, bast fibers may be used instead of other types of reinforcing fibers such as carbon fibers or glass fibers when manufacturing structural and semi-structural composite components.

### SUMMARY

A composite panel includes a polymer matrix and a plurality of reinforcing fibers encapsulated in the polymer matrix. The plurality of reinforcing fibers includes bast fibers having a predetermined bending length greater than 80 μm and less than 2 mm.

In other features, the plurality of reinforcing fibers are discontinuous fibers and are not aligned in the composite panel. The plurality of reinforcing fibers are discontinuous fibers and are aligned in a predetermined direction in the composite panel. The reinforcing fibers comprise at least one of continuous fiber tows and twine that are spun together.

In other features, the at least one of the continuous fiber tows and twine are aligned in the composite panel. The at least one of the continuous fiber tows and twine are attached to a surface of a backing sheet using stitches. The polymer matrix, the backing sheet, and the at least one of the continuous fiber tows and twine are encapsulated in the polymer matrix. The reinforcing fibers comprise cloth that is woven from at least one of continuous fiber tows and twine including the reinforcing fibers that are spun together.

In other features, the bast fibers comprise flax. The polymer matrix is opaque. The predetermined bending length is greater than 80 μm and less than 1 mm.

A composite panel comprise a polymer matrix and at least one of continuous fiber tows and twine, wherein the at least one of the continuous fiber tows and twine are encapsulated in the polymer matrix. The at least one of continuous fiber tows and twine includes bast fibers having a predetermined bending length greater than 80 μm and less than 2 mm that are spun together.

In other features, the at least one of the continuous fiber tows and twine are aligned in a first direction in the composite panel. The at least one of the continuous fiber tows and twine are attached to a surface of a backing sheet using stitches. The polymer matrix, the backing sheet, and the at least one of the continuous fiber tows and twine are encapsulated in the polymer matrix.

In other features, the bast fibers comprise flax. The polymer matrix is opaque. The predetermined bending length is greater than 80 μm and less than 1 mm.

A composite panel includes a polymer matrix and woven cloth encapsulated in the polymer matrix. The woven cloth comprises at least one of continuous fiber tows and twine that are woven together. The at least one of the continuous fiber tows and twine comprise a plurality of bast fibers having bending lengths greater than 80 μm and less than 2 mm that are spun together.

In other features, the woven cloth is attached to a surface of the backing sheet using stitches. The polymer matrix, the backing sheet, and the woven cloth are encapsulated in the polymer matrix.

In other features, the bast fibers comprise flax. The polymer matrix is opaque. The predetermined bending length is greater than 80 μm and less than 1 mm.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a flowchart of an example of a method for processing bast fiber;

FIG. 2 is a cross-sectional view of an example of a bast fiber;

FIG. 3 is a simplified side cross-sectional view illustrating an example of a roller system for processing randomly oriented bast fibers;

FIG. 4 is a flowchart of an example of a method for processing bast fibers according to the present disclosure;

FIG. 5 is a simplified side cross-sectional view illustrating an example of a roller system for processing aligned bast fibers according to the present disclosure;

FIG. 6A is a partial cross-sectional view of an example of a roller system;

FIG. 6B is shear force diagram for the roller system of FIG. 6A;

FIG. 6C is bending moment diagram for the roller system of FIG. 6A;

FIG. 7A is a partial cross-sectional view of an example of a roller system for processing bast fibers according to the present disclosure;

FIG. 7B is shear force diagram for the roller system of FIG. 7A;

FIG. 7C is bending moment diagram for the roller system of FIG. 7A;

FIG. 8A is a partial cross-sectional view of an example of a roller system for processing bast fibers according to the present disclosure;

FIG. 8B is shear force diagram for the roller system of FIG. 8A;

FIG. 8C is bending moment diagram for the roller system of FIG. 8A;

FIG. 9A shows an example of bast fibers with shorter, random bending lengths;

FIG. 9B show examples of bast fibers with bending lengths greater than a predetermined minimum bending length according to the present disclosure;

FIG. 10 is a composite panel including discontinuous reinforcing fibers that are randomly arranged and that include bast fibers having predetermined minimum bending lengths according to the present disclosure;

FIG. 11 are examples of composite panels including discontinuous reinforcing fibers that are aligned and that include bast fibers having predetermined minimum bending lengths according to the present disclosure;

FIGS. 12A to 12C are examples of composite panels including continuous reinforcing fiber tows or twine that are spun from bast fibers having predetermined minimum bending lengths according to the present disclosure; and

FIGS. 13A and 13B are examples of composite panels including continuous reinforcing fibers that are spun and woven from bast fibers having predetermined minimum bending lengths according to the present disclosure.

In the drawings, reference numbers may be reused to identify similar and/or identical elements.

### DETAILED DESCRIPTION

While composites with bast fibers having minimum bending lengths are described below in the context of vehicle applications, the composites with bast fibers can be used in other applications.

Natural fibers include bast, leaf, seed, wood, and grass stem. Bast fibers include flax, hemp, jute, ramie and kenaf. Bast fibers such as flax can be used as reinforcing fibers in a polymer matrix. For example, the reinforcing fibers can be mixed with polymer and used in injection molding, molding of structural and semi-structural composites, and additive manufacturing such as 3D printing of components.

Flax fibers have excellent properties for use as reinforcing fibers such as a density of approximately 1.38 g/cm³, a tensile strength of 700 to 1000 MPa, a Young's modulus of 60-70 GPa, and an elongation of 2.3% at break.

During processing of bast fibers, the fibers are fed in a random, misaligned manner and bending lengths of the fibers vary after passing through the roller system during scutching/breaking. Bending length refers to the distance between adjacent bends of a bast fiber after passing through the roller system. In other words, as the fibers pass through the roller systems, the fibers are bent at fiber bending lengths that are relatively short (e.g., typically less than 30 μm). The fibers break at variable fiber lengths.

The roller systems described below control the bending lengths such that they are greater than a predetermined minimum bending length. As a result, the bast fibers (such as flax stems) have variable lengths and bending lengths greater than a predetermined minimum bending length. Fibers that have bending lengths greater than the predetermined minimum bending length allow complete load transfer from the fibers to the polymer matrix. Fiber lengths produced by conventional scutching/breaking processes are substantially shorter the predetermined minimum bending length and therefore do not allow complete load transfer from the fibers to the polymer matrix.

In some examples, the predetermined minimum bending length is greater than 80 μm. In some examples, the predetermined minimum bending length is greater than 100 μm. In some examples, the predetermined minimum bending length is greater than 230 μm. In some examples, the predetermined minimum bending length is greater than 460 μm. In some examples, the predetermined minimum bending length is in a range from 80 μm to 2 mm. some examples, the predetermined minimum bending length is in a range from 230 μm to 1 mm. For example, the predetermined minimum bending length may be selected using the relationship

$${l}_{c} = \frac{{σ}_{f} d}{2 {τ}_{i}} ,$$

where l_{c} is the critical fiber length, d is a fiber diameter, σ_{f} is a fiber tensile strength, and τᵢ is the interfacial shear strength. Using typical values of σ_{f} (850 MPa), d (18 μm), and τᵢ (33 MPa), the critical length would be 232 μm. In some examples, two times the critical length is used (e.g., 464 μm). These values will differ depending upon the specific fibers and polymer matrix that are used.

The length of the bast fibers typically varies after passing through the roller system. In some examples, the length of bast fibers such as flax fibers can be as high as 30 inches (or perhaps longer) prior to scutching/breaking. After passing through the roller systems described herein, the bast fibers are bent and have bending lengths that are greater than a predetermined minimum bending length. The fibers break at variable lengths so that the fiber is not straight, but the individual bends may still be connected.

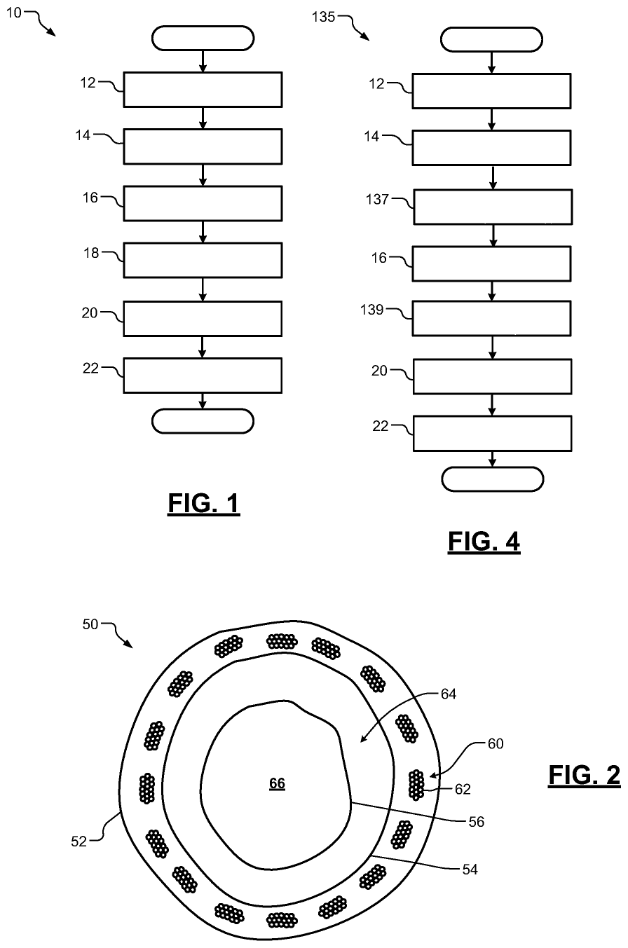

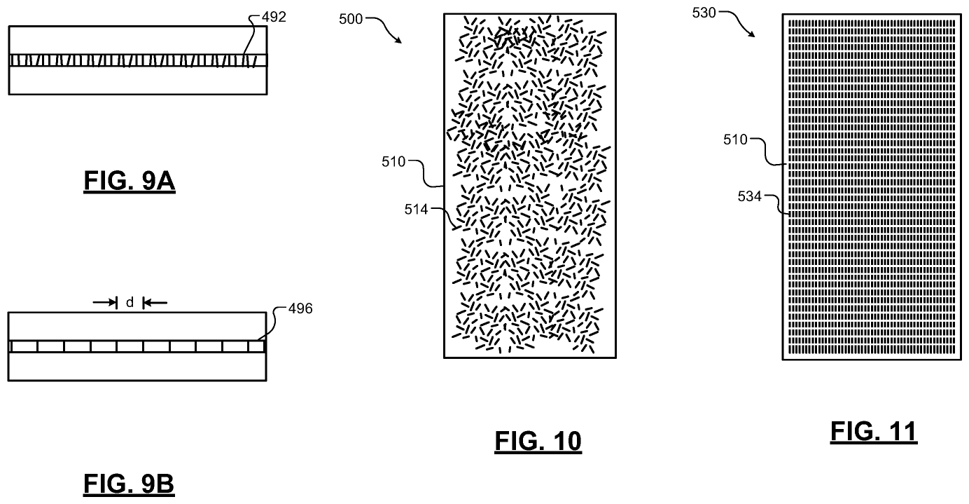

In the description that follows, FIGS. 1 to 8B show examples of methods for processing bast fibers with bending lengths that are greater than the predetermined minimum bending length. Additional details regarding processing of bast fibers with bending lengths greater than the predetermined minimum bending length can be found in commonly assigned U.S. patent application Ser. No. 17/960,232, entitled “ROLLERS FOR BAST FIBER BREAKING PROCESS”, filed on Oct. 5, 2022, which is hereby incorporated by reference in its entirety. FIGS. 9A to 13B illustrate examples of composites including the bast fibers with bending lengths greater than the predetermined minimum bending length.

Referring now to FIG. 1, a flowchart of a method 10 for processing bast fiber is shown. At 12, bast plants are cultivated. Seeds are planted and stalks grow fairly quickly. When the bast plant reaches a height of 3′ to 4′ after a few months, the bast plant is harvested.

At 14, retting is performed. Retting involves decomposition of woody matter enclosing the fibers. At 16, scutching/breaking is performed. When the decomposed woody tissue dries, the fibers are fed through rollers of a roller system and crushed. The scutching/breaking process separates the woody matter from the fibers. At 18, combing/heckling is performed to separate coarse fiber bundles from finer bundles and to arrange the fibers generally parallel to one another.

In some examples, the bast fibers are spun into fiber tow or twine at 20. The fiber tow or twine can be used as a reinforcing fiber in a composite. Alternately, the fiber tow or twine can be woven into cloth at 22.

Referring now to FIG. 2, a bast fiber 50 is shown. The bast fiber 50 includes an epidermis or outer layer 52, a middle layer 54, and an inner layer 56. A plurality of fiber cells 60 including a fiber bundles 62 are arranged between the outer layer 52 and the middle layer 54. A woody body or shive 64 is arranged between the middle layer 54 and the inner layer 56. A hollow space 66 is located inside of the inner layer 56.

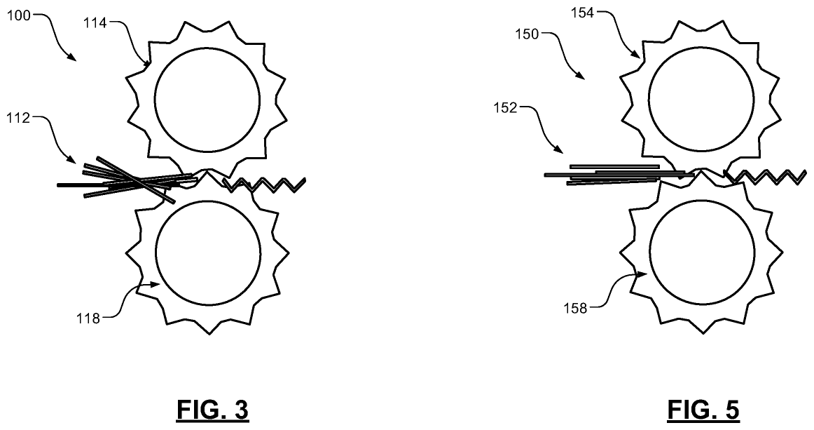

Referring now to FIG. 3, a roller system 100 for processing bast fibers with bending lengths that are variable and shorter than the predetermined minimum bending lengths includes a first roller 114 and a second roller 118. Typically, the first roller 114 and the second roller 118 include teeth having the same size and profile (e.g., both are fluted and have a generally triangular profile). Normally, the bast fibers are randomly oriented as the fibers enter the roller system 100. As a result, the roller system 100 creates bast fibers that are misaligned and have shorter and/or variable bending lengths. The shorter and/or variable bending lengths in the bast fibers are generally not suitable for use as reinforcing fibers in a polymer matrix. The fiber bending lengths are substantially shorter than the predetermined minimum bending length and therefore will not allow complete load transfer from the fibers to the polymer matrix. In the event that the fiber is not fully broken, bends, creases, or other defects are typically introduced to the longer length fiber.

Referring now to FIG. 4, a method 135 for processing bast fibers with bending lengths greater than a predetermined bending length is shown. The method 135 aligns the bast fibers at 137 (e.g., such as combing/heckling or passing the bast fibers through a tube or channel). The aligning at 137 is performed prior to the scutching/breaking at 16 to align the longitudinal lengths of the bast fibers before the fibers enter the roller systems that perform scutching/breaking. Furthermore, the scutching/breaking at 16 is performed using roller systems that load the bast fibers in shear mode rather than bending mode as described further below. Combing/heckling can also be performed at 139 after scutching/breaking at 16.

In some examples, the bast fibers are spun into fiber tow or twine at 20. The fiber tow or twine can be used as a reinforcing fiber in a composite. Alternately, the fiber tow or twine can be woven into cloth at 22.

Referring now to FIG. 5, a roller system 150 for processing bast fibers includes a first roller 154 and a second roller 158. The bast fibers are aligned prior to scutching/breaking (rather than being randomly oriented as above). In some examples, the first roller 154 and the second roller 158 have tooth profiles described further below. The roller system 150 is configured to control the failure/fracture (breaking/bending) of the woody material during the breaking process.

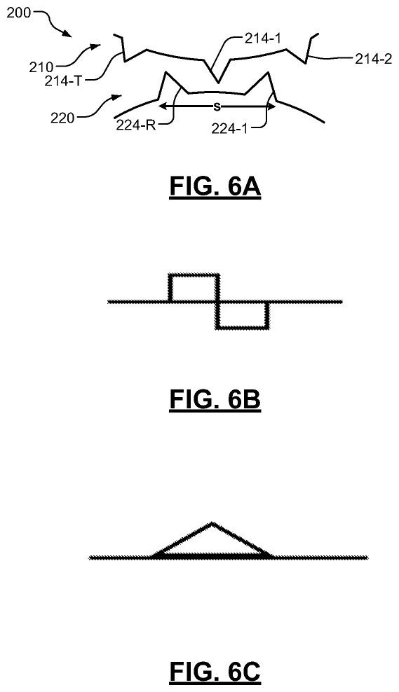

Referring now to FIG. 6A, an example of a roller system 200 that is configured to load the bast fiber in a bending mode is shown. The roller system 200 includes a first roller 210 including a first plurality of teeth 214-1, 214-2, . . . , and 214-T, where T is an integer greater than 1. The roller system 200 includes a second roller 220 including a second plurality of teeth 224-1, . . . , and 214-R, where R is an integer greater than 1. In some examples, the first plurality of teeth 214-1, 214-2, . . . , and 214-T and the second plurality of teeth 224-1, . . . , and 224-R have the same profile and size (e.g., a triangular profile). One of the plurality of teeth 214-1, 214-2, . . . , and 214-T is aligned or centered between a pair of the plurality of teeth 224-1, . . . , and 224-R.

In FIG. 6B, a shear force diagram for the roller system 200 of FIG. 6A is shown. In FIG. 6C, a bending moment diagram for the roller system 200 of FIG. 6A is shown. As can be appreciated, the roller system 200 is configured to load the bast fibers in a bending mode.

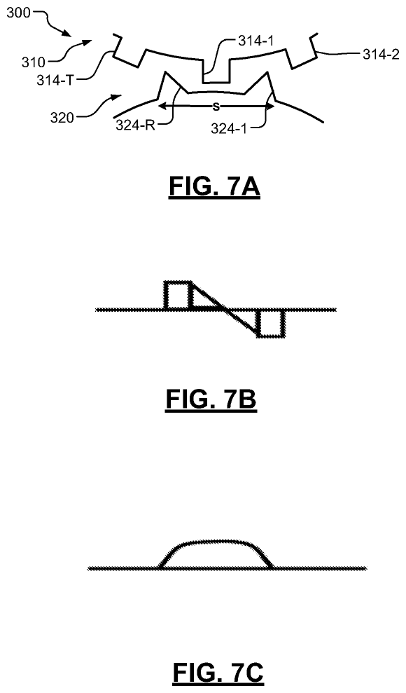

Referring now to FIG. 7A, a roller system 300 is configured to load the bast fiber in a shear mode. The roller system 300 includes a first roller 310 including a first plurality of teeth 314-1, 314-2, . . . , and 314-T, where T is an integer greater than 1. The roller system 300 includes a second roller 320 including a second plurality of teeth 324-1, . . . , and 324-R, where R is an integer greater than 1. The first roller 310 and the second roller 320 rotate about an axle (not shown) that is attached to a frame or other support (not shown). For example, a motor, hand crank or other device can be used to rotate the rollers.

In some examples, each of the first plurality of teeth 314-1, 314-2, . . . , and 314-T has rectangular tooth profile. In some examples, each of the plurality of teeth 324-1, . . . , and 324-R has a triangular profile, a rectangular profile, or another suitable tooth profile. One of the first plurality of teeth 314-1, 314-2, . . . , and 314-T is aligned or centered between an adjacent pair of the second plurality of teeth 324-1, . . . , and 324-R.

In some examples, the bast stems have a diameter in a range from 0.5 to 3 mm. A span s between the plurality of teeth 324-1, . . . , and 324-R is in a range from 4 to 7 times the thickness/diameter of the bast stems. In other words, the span is in a range from 2 mm to 21 mm.

In some examples, the bast stems have a diameter in a range from 2 to 3 mm. A span s between the plurality of teeth 324-1, . . . , and 324-R is in a range from 4 to 7 times the thickness/diameter of the bast stems. In other words, the span is in a range from 8 mm to 21 mm. The roller system 300 in FIG. 7A provides a modified short beam shear design to impart shear failure. As can be appreciated, the roller system 300 is configured to load the bast fibers in a shear mode.

In FIG. 7B, a shear force diagram for the roller system of FIG. 7A is shown. In FIG. 7C, a bending moment diagram for the roller system of FIG. 7A is shown. As can be appreciated, the roller system 300 is configured to load the bast fibers in a shear mode and to produce bast fibers having the predetermined length.

The roller systems described herein control bending locations of the bast fiber (such as a flax stem) to a length greater than the predetermined minimum bending length required for use in semi-structural and structural composites. In some examples, the predetermined minimum bending length is greater than 80 μm. In some examples, the predetermined minimum bending length is greater than 100 μm. In some examples, the predetermined minimum bending length is greater than 230 μm. In some examples, the predetermined minimum bending length is greater than 460 μm. In some examples, the predetermined minimum bending length is in a range from 100 μm to 2 mm. some examples, the predetermined minimum bending length is in a range from 230 μm to 1 mm.

Using a shearing process, the fiber bundle is loaded under different conditions that use a lower energy shearing failure mode to separate the fiber bundle from the stem. The fiber bending length dictates the mechanical bending/breaking process and gear tooth spacing for the roller system for bast fibers. Furthermore, the roller systems according to the present disclosure use a shear mode to drive extraction of fiber bundles from woody stems as opposed to a bending failure mode.

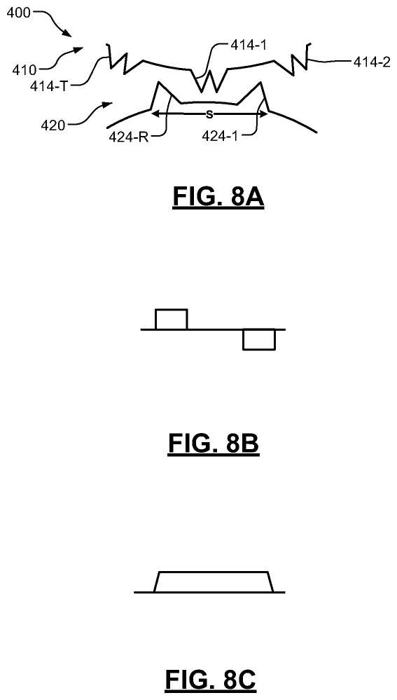

Referring now to FIG. 8A, a roller system 400 is configured to load the bast fiber in a shear mode is shown. The roller system 400 includes a first roller 410 including a first plurality of teeth 414-1, 414-2, . . . , and 414-T, where T is an integer greater than 1. The roller system includes a second roller 420 including the second plurality of teeth 424-1, . . . , and 414-R, where R is an integer greater than 1.

In some examples, each of the first plurality of teeth 414-1, 414-2, . . . , and 414-T has a “W”-shaped cross section (including a pair of adjacent triangular tooth sub-portions). Each of the first plurality of teeth 424-1, . . . , and 414-R has a “W”-shaped profile, a triangular profile, a rectangular profile, or another suitable tooth profile. One of the first plurality of teeth 414-1, 414-2, . . . , and 414-T is aligned or centered between an adjacent pair of the second plurality of teeth 424-1, . . . , and 414-R.

In FIG. 8B, a shear force diagram for the roller system 400 of FIG. 8A is shown. In FIG. 8C, a bending moment diagram for the roller system 400 of FIG. 8A is shown. As can be appreciated, the roller system 400 is configured to load the bast fibers in a shear mode and to produce bast fibers having the predetermined length.

Referring now to FIG. 9A, a bast fiber 490 is shown after scutching/breaking using the methods described herein (e.g., aligned fibers supplied to a fluted roller system described herein). The bast fibers 496 have bending lengths greater than or equal to the predetermined minimum bending length.

Referring now to FIG. 10, a composite panel 500 includes discontinuous reinforcing fibers 514 including bast fibers have bending lengths greater than the predetermined minimum bending lengths. The discontinuous reinforcing fibers 514 are encapsulated in a polymer matrix 510. The discontinuous reinforcing fibers 514 are randomly arranged in the polymer matrix 510. In some examples, additive manufacturing is used to deliver a heated mixture including polymer and reinforcing fibers to successively print layers of the composite until a final shape of the composite is printed.

Referring now to FIG. 11, a composite panel 530 includes discontinuous reinforcing fibers 534 including bast fibers have bending lengths greater than a predetermined minimum bending length. The discontinuous reinforcing fibers 534 are encapsulated in a polymer matrix 510. The discontinuous reinforcing fibers 514 are aligned in the polymer matrix 510.

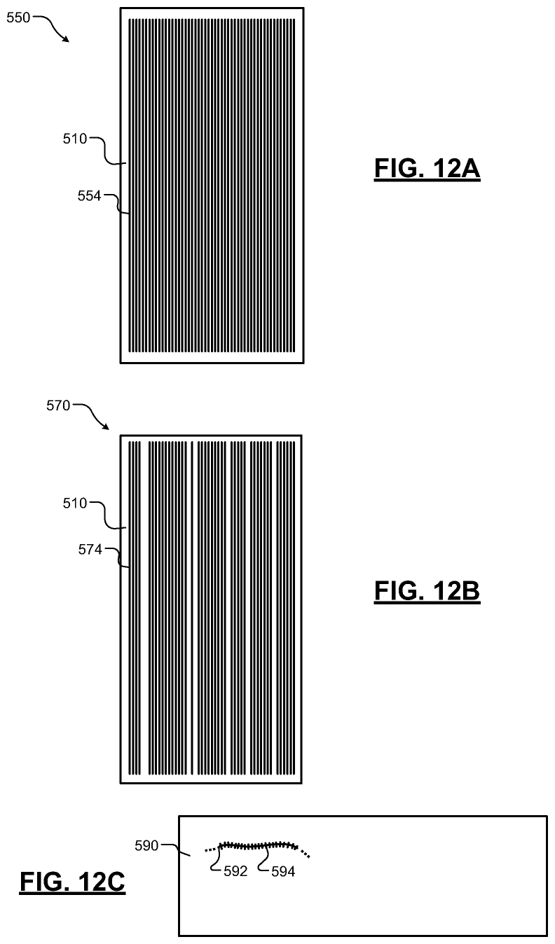

Referring now to FIGS. 12A and 12B, a plurality of the bast fibers can be spun into fiber tow or twine to produce continuous reinforcing fibers. In FIG. 12A, a composite panel 550 includes continuous reinforcing fibers 554 including fiber tow or twine (including a plurality of spun bast fibers having bending lengths greater than the predetermined length). The continuous reinforcing fibers 554 are encapsulated in a polymer matrix 510. The continuous reinforcing fibers 554 are shown aligned in the polymer matrix 510.

In some examples, the continuous reinforcing fibers 554 are positioned by a robot and stitched onto a backing sheet in a predetermined pattern and/or density using tailored fiber placement (TFP). TFP uses a computer numerical controlled robot to stitch the fiber tows or twine onto a backing sheet using stitches. After the fiber tows or twine are attached, the backing sheet and fiber tows are encapsulated in polymer. In FIG. 12B, a composite panel 570 includes a plurality of continuous reinforcing fibers 574 having variable density in a horizontal direction. As can be appreciated, the continuous reinforcing fibers 574 can also be arranged over one another and/or placed/aligned in any direction.

In FIG. 12C, fiber tows 592 are arranged on one surface of a backing sheet 590. Stitches 594 are used to attach the fiber tows 592 to the backing sheet 590 to define a pattern and/or density of the fiber tows. After the fiber tows 592 are arranged and stitched, the surface of the backing sheet 590 is encapsulated in the polymer matrix.

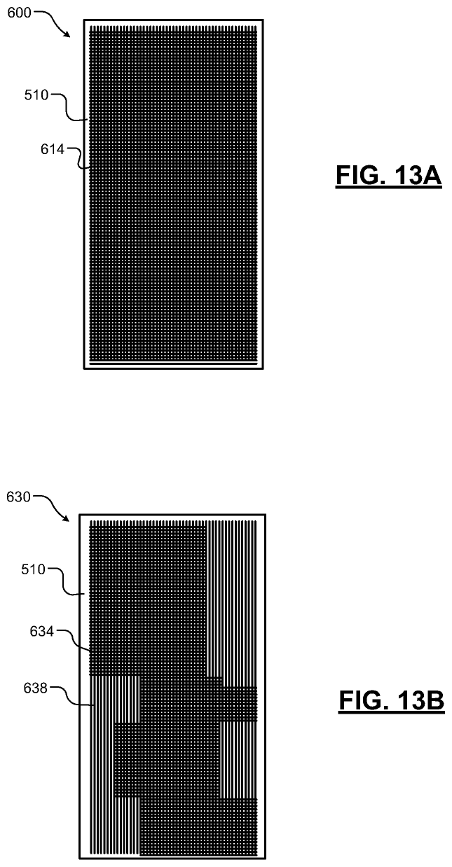

Referring now to FIGS. 13A and 13B, a plurality of bast fibers is spun into fiber tow (or twine) and then the fiber tow or twine is woven into cloth. In FIG. 13A, a composite panel 600 includes cloth 614 woven from fiber tows or twine (spun continuous reinforcing fibers with bending lengths greater than the predetermined minimum bending lengths). The cloth 614 is encapsulated in a polymer matrix 510. In some examples, the cloth 614 is stitched onto a backing sheet in a predetermined pattern using tailored fiber placement (TFP) and then encapsulated in polymer as described above. In FIG. 13B, a composite panel 630 includes portions that are reinforced by both cloth 634 and reinforcing fibers 638.

While the foregoing examples described the use of bast fibers in the polymer matrix, the bast fibers can be comingled with other types of reinforcing fibers that are not bast fibers (e.g., such as carbon fibers, glass fibers, etc.).

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A composite panel, comprising:
a polymer matrix; and
a plurality of reinforcing fibers encapsulated in the polymer matrix,
wherein the plurality of reinforcing fibers includes bast fibers having a predetermined bending length greater than 80 μm and less than 2 mm.

2. The composite panel of claim 1, wherein the plurality of reinforcing fibers are discontinuous fibers and are not aligned in the composite panel.

3. The composite panel of claim 1, wherein the plurality of reinforcing fibers are discontinuous fibers and are aligned in a predetermined direction in the composite panel.

4. The composite panel of claim 1, wherein the reinforcing fibers comprise at least one of continuous fiber tows and twine that are spun together.

5. The composite panel of claim 4, wherein the at least one of the continuous fiber tows and twine are aligned in the composite panel.

6. The composite panel of claim 4, further comprising:
a backing sheet,
wherein the at least one of the continuous fiber tows and twine are attached to a surface of the backing sheet using stitches, and
wherein the polymer matrix, the backing sheet, and the at least one of the continuous fiber tows and twine are encapsulated in the polymer matrix.

7. The composite panel of claim 1, wherein the reinforcing fibers comprise cloth that is woven from at least one of continuous fiber tows and twine including the reinforcing fibers that are spun together.

8. The composite panel of claim 1, wherein the bast fibers comprise flax.

9. The composite panel of claim 1, wherein the polymer matrix is opaque.

10. The composite panel of claim 1, wherein the predetermined bending length is greater than 80 μm and less than 1 mm.

11. A composite panel, comprising:
a polymer matrix; and
at least one of continuous fiber tows and twine, wherein the at least one of the continuous fiber tows and twine are encapsulated in the polymer matrix,
wherein the at least one of continuous fiber tows and twine includes bast fibers having a predetermined bending length greater than 80 μm and less than 2 mm that are spun together.

12. The composite panel of claim 11, wherein the at least one of the continuous fiber tows and twine are aligned in a first direction in the composite panel.

13. The composite panel of claim 11, further comprising:
a backing sheet,
wherein the at least one of the continuous fiber tows and twine are attached to a surface of the backing sheet using stitches, and
wherein the polymer matrix, the backing sheet, and the at least one of the continuous fiber tows and twine are encapsulated in the polymer matrix.

14. The composite panel of claim 11, wherein:
the bast fibers comprise flax, and
the polymer matrix is opaque.

15. The composite panel of claim 11, wherein the predetermined bending length is greater than 80 μm and less than 1 mm.

16. A composite panel, comprising:
a polymer matrix; and
woven cloth encapsulated in the polymer matrix,
wherein the woven cloth comprises at least one of continuous fiber tows and twine that are woven together, and
wherein the at least one of the continuous fiber tows and twine comprise a plurality of bast fibers having bending lengths greater than 80 μm and less than 2 mm that are spun together.

17. The composite panel of claim 16, further comprising:
a backing sheet,
wherein the woven cloth is attached to a surface of the backing sheet using stitches, and
wherein the polymer matrix, the backing sheet, and the woven cloth are encapsulated in the polymer matrix.

18. The composite panel of claim 16, wherein:
the bast fibers comprise flax, and
the polymer matrix is opaque.

19. The composite panel of claim 16, wherein the predetermined bending length is greater than 80 μm and less than 1 mm.
